(19) United States
(12) Patent Application Publication
(10) Pub. No.: US 2015/0310419 A1
(43) Pub. Date: Oct. 29, 2015

(54) CARDLESS POINT-OF-SALE PAYMENT METHOD

(71) Applicant: BUY IT MOBILITY NETWORKS INC., Atlanta, GA (US)

(72) Inventors: Aydin A. Kadaster, New York, NY (US); Michael L. Reidenbach, Alpharetta, GA (US); Paul Voulas, New York, NY (US)

(73) Assignee: BUY IT MOBILITY NETWORKS INC., Atlanta, GA (US)

(21) Appl. No.: 14/260,578

(22) Filed: Apr. 24, 2014

(51) Int. Cl. G06Q 20/32; G06Q 20/20; G06Q 20/40

(52) U.S. Cl. CPC G06Q 20/3278; G06Q 20/4012; G06Q 20/204

(57) ABSTRACT

A cardless point-of-sale payment method capable of completing patient transactions when a connection to a wireless network is not available is provided, including verifying a personal identification number (PIN) provided to an application installed on a registered mobile internet device, retrieving a backup authorization token from a memory of the registered mobile internet device, displaying the backup authorization token on the registered mobile internet device for entry to a point-of-sale device, providing sale transaction information to a purchase authorization processing company (APC) via a transmission between the point-of-sale device and the APC wherein the sale transaction information includes the backup authorization token and a sale transaction value, verifying the backup authorization token, verifying the sale transaction value against an approved transaction value associated with the backup authorization token, providing an approval to the point-of-sale device via a transmission between the APC and the point-of-sale device, and completing the payment.

### BACKGROUND

Cardless payment systems and methods provide a convenient way to conduct payment transactions. Pre-existing wireless electronic cardless payment systems are not capable of completing payment transactions when a connection to a wireless network is unavailable. This shortcoming prevents the pre-existing cardless payment systems from being utilized in areas where no wireless network is available or in the case that a wireless network is temporarily disabled.

### SUMMARY

In light of the above, the present inventors have provided cardless point-of-sale payment processes and systems that allow the completion of payment transactions even in the absence of a wireless network connection.

Provided in one embodiment of the invention is a cardless point-of-sale payment method. The method includes verifying a personal identification number (PIN) provided to an application installed on a registered mobile internet device, retrieving a backup authorization token from a memory of the registered mobile internet device, displaying the backup authorization token on the registered mobile internet device for entry into a point-of-sale device, providing sale transaction information to a purchase authorization processing company (APC) via a transmission between the point-of-sale device and the APC wherein the sale transaction information includes the backup authorization token and a sale transaction value, verifying the backup authorization token, verifying the sale transaction value against an approved transaction value associated with the backup authorization token, providing an approval to the point-of-sale device via a transmission between the APC and the point-of-sale device, and completing the payment.

In another embodiment, a method of operating a cardless point-of-sale payment system utilizing a computer network and a wireless network, comprising associating a consumer's account with an account origination merchant, verifying the use of the consumer's account to complete a transaction with a second merchant utilizing the cardless point-of-sale payment system, and providing a payment to the account origination merchant.

In another embodiment, a non-transitory computer readable medium is provided. The non-transitory computer readable medium comprises a software program configured to verity a personal identification number (PIN) provided to an application installed on a registered mobile internet device, retrieve a backup authorization token from a memory of the registered mobile internet device, and display the backup authorization token on the registered mobile internet device for entry to a point-of-sale device.

In another embodiment, a registered mobile internet device, comprising a backup authorization token is provided.

### BRIEF DESCRIPTION OF THE DRAWINGS

The skilled artisan will understand that the drawings primarily are for illustrative purposes and are not intended to limit the scope of the inventive subject matter described herein. In the drawings, like reference characters generally refer to like features (e.g., functionally similar and/or structurally similar elements).

FIG. 1 depicts a flow-chart for a process of preparing a mobile internet device for use with a cardless point-of-sale system, according to one embodiment.

FIG. 2 depicts a flow-chart for a process of completing a cardless point-of-sale payment transaction utilizing a backup authorization token, according to one embodiment.

FIG. 3 depicts a flow-chart for a process of completing a cardless point-of-sale payment transaction utilizing a backup authorization token including unsuccessfully attempting to connect a mobile internet device to an APC via a wireless network, according to one embodiment.

FIG. 4 depicts a flow-chart for a process of completing a cardless point-of-sale payment transaction utilizing a backup authorization token in an open-loop application, according to one embodiment.

FIG. 5 depicts a flow-chart for a process of completing a cardless point-of-sale payment transaction utilizing a backup authorization token where multiple payment tender accounts are associated with the APC account, according to one embodiment.

FIG. 6 depicts a flow-chart for a process of completing a cordless point-of-sale payment transaction utilizing a backup authorization token including providing a replacement backup authorization token to the mobile internet device, according to one embodiment.

FIG. 7 depicts a flow-chart for a process of completing a cardless point-of-sale payment transaction utilizing a backup authorization token including the display of coupons on the mobile internet device, according to one embodiment.

FIG. 8 depicts a flow-chart for a process of completing a cardless point-of-sale payment transaction utilizing a backup authorization token including the display of marketing information on the mobile internet device, according to one embodiment.

FIG. 9 depicts a flow-chart for a process of completing a cardless point-of-sale payment transaction utilizing a backup authorization token including displaying an approved transaction amount associated with the backup authorization token on the mobile internet device, according to one embodiment.

FIG. 10 depicts a flow-chart for a process of completing a cardless point-of-sale payment transaction utilizing a backup authorization token wherein the backup authorization is associated with a gift card account, according to one embodiment.

FIG. 11 depicts a flow-chart for a process of completing a cardless point-of-sale payment transaction utilizing a multiple-use backup authorization token, according to one embodiment.

FIG. 12 depicts a flow-chart for a process of operating a cardless point-of-sale payment system, according to one embodiment.

FIG. 13 depicts a schematic diagram of a computer network utilized to operate a cardless point-of-sale payment system, according to one embodiment.

FIG. 14 depicts a mobile internet device screen displaying an authorization token, according to one embodiment.

### DETAILED DESCRIPTION

Following below are more detailed descriptions of various concepts related to, and embodiments of, cardless point-of-sale payment methods. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

A cardless point-of-sale payment system is disclosed in U.S. patent application Ser. No. 12/848,643, incorporated herein by reference in its entirety.

The cardless point-of-sale method may utilize a software based solution to facilitate payment of a merchant utilizing a mobile internet device. The software based implementation may utilize a merchant's existing point-of-sale device, providing the benefit of reducing the cost of implementation.

The software based implementation may include the installation of a software application on the mobile internet device. The application may be installed on the mobile internet device by any suitable means. According to one embodiment, the application may be downloaded to the mobile internet device from an “application store” facilitated by a third party.

The application installed on the mobile internet device may be a merchant specific application. A merchant specific application appears to the consumer to offer access to only the designated merchant, and utilizes the cardless point-of-sale payment system operated by the APC to process payment transactions. Merchant specific applications may be referred to as “closed-loop” applications. According to one embodiment, closed-loop applications may acknowledge that payment transfers are completed utilizing the cardless point-of-sale system—i.e. the closed loop application may be transparently branded as utilizing the cardless point-of-sale payment system. In another embodiment, a closed-loop application may not acknowledge that the cardless point-of-sale payment system is utilized to complete the payment transaction. According to another embodiment, the application installed on the mobile internet device may be a cardless point-of-sale payment application that allows payment to a plurality of participating merchants utilizing a single application. Applications that allow payment to a plurality of participating merchants may be referred to as “open-loop” applications.

The mobile internet device and the point-of-sale device are connected to a purchase authorization processing company (APC) by a computer network. The point-of-sale device may be connected by a wired connection or a wireless connection of the type utilized by the mobile internet device. The APC processes the cardless point-of-sale payment transactions between a consumer and a merchant, wherein the consumer utilizes the mobile internet device and the merchant utilizes the point-of-sale device.

To utilize the cardless point-of-sale payment system a consumer establishes an account with the APC. The account may be established by utilizing the application installed on the mobile internet device or a website associated with the APC. To establish an account the consumer provides information including personal information, financial information, an email address, a user name and a password. In some embodiments, the user name may be the same as the email address. The consumer may also establish a Personal Identification Number (PIN). In one embodiment, the PIN may be a number, alphanumeric code, voice print, fingerprint, or other biometric identification. The personal information may include personally identifying information regarding the consumer, including at least the consumer's name and address. The financial information includes at least information related to a bank account or accounts the consumer intends to associate with the APC account.

The point-of-sale device may be any device capable of carrying out a purchase transaction and connecting to the APC. According to one embodiment, the point-of-sale device may be a cash register, website or a point-of-sale application installed on a mobile internet device. In the case that the point-of-sale device is a website, the cardless point-of-sale payment system may be utilized to complete web based payment transactions—e.g., payments to merchants selling goods and/or services online. The connection between the point-of-sale device and the APC may be accomplished via a computer network, including both wired and wireless computer networks. In one embodiment, the point-of-sale device may connect to the APC over the internet.

The mobile internet device is capable of connecting to the internet over a wireless data network. According to one embodiment, the mobile internet device may be a smartphone or tablet. The wireless data network may be any suitable wireless network capable of communicating data. According to one embodiment, the wireless data, network may be a Wi-Fi network or a cellular data network. In one embodiment, the wireless network may be a secure network.

According to one embodiment, the bank account or accounts associated with the APC account may be checking accounts. In other embodiments credit card accounts, debit card accounts or gift card accounts may be associated with the APC account.

The APC then verifies the information provided by the consumer and assigns an APC account number to the consumer's APC account. The verification may include a review of the consumer's financial information to determine a transaction amount for which the consumer is pre-approved. The review of financial information may include a review of the consumer's credit score and history as reported by one or all of the credit reporting services in addition to a review of the balance of the bank account or accounts. The verification of the consumer's financial information results in the status of the consumer's APC account switching from pending to active. According to one embodiment the APC may additionally verify the consumer's identity, the consumer's ability to access the bank account or accounts, the authenticity of personal information provided by the consumer and/or any additional information provided by the consumer for the purpose of establishing an account with the APC.

The APC account is then associated with the application installed on the mobile internet device. In the case that the APC account was established through a website associated with the APC, associating the APC account with the application may include installing the application on the mobile internet device, and entering the username and password associated with the APC account. Upon the successful association of an APC account with the application installed on the mobile internet device, the APC account number, the consumer's first and last name, the status of the APC account and a backup authorization token are transmitted from the APC to the mobile internet device. In the case that the consumer established a PIN when creating the APC account, the PIN is also transmitted to the mobile internet device. If a PIN was not previously established, the consumer may create a PIN within the application installed on the mobile internet device. The information transmitted from the APC to the mobile internet device and the PIN may be stored in a memory of the mobile internet device, producing a registered mobile internet device.

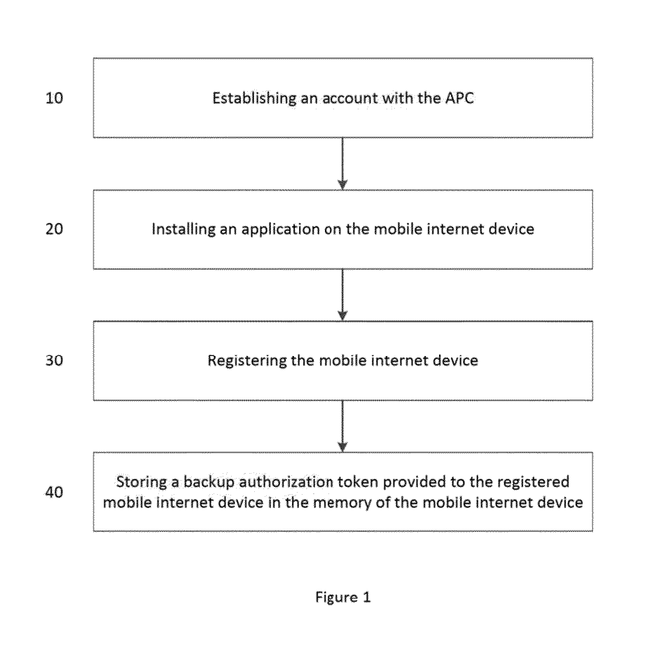

An exemplary process for preparing the mobile internet device for use with the cardless point-of-sale system is depicted in FIG. 1. The process includes establishing an account with the APC 10, installing the application on the mobile internet device 20, registering the mobile internet device 30, and storing the backup authorization token provided to the registered mobile internet device in the memory of the registered mobile internet device 40. According to some embodiments, installing the application on the mobile internet device 20 may occur before establishing an account with the APC 10.

Additional security measures may be activated by the consumer within the application installed on the mobile internet device. According to one embodiment, the consumer may upload a photograph to the application installed on the mobile internet device for purposes of identification. The photograph may be stored in a memory of the mobile internet device, and retrieved from the memory and displayed when the application is utilized to conduct cardless point-of-sale payment transactions.

To conduct a payment transaction with the cardless point-of-sale payment application the consumer utilizes the application installed on the mobile internet device to retrieve an authorization token and presents the authorization token for entry to the merchant's point-of-sale device. The merchant's point-of-sale device then transmits the authorization token and a sale transaction value to the APC. The APC then verities the authorization token and sale transaction value, provides an approval message to the point-of-sale device and completes the payment transfer to the merchant. The payment to the merchant may be accomplished by a transfer of funds to the merchant initiated immediately. According to another embodiment, the payment to the merchant may be accomplished by as part of a periodic transfer of fund to the merchant, for example a once daily transfer, once monthly transfer, or any other appropriate periodic payment schedule.

To retrieve an authorization token, the consumer may provide the PIN to the application installed on the mobile internet device. The mobile internet device then verifies that the PIN matches the PIN stored in the memory of the mobile internet device. The process for retrieval of the authorization token may include additional steps depending on the type of application installed on the mobile internet device and the availability of a wireless connection to the mobile internet device. According to another embodiment, an authorization token may be retrieved without providing a PIN to the application end verification of the PIN.

In the case where the mobile internet device is able to successfully connect to the APC via the wireless network, the application installed on the mobile internet device transmits the APC account number to the APC. The APC then verifies that the APC account number is valid and that the APC account associated with the APC account number is in active status. After verification, the APC transmits an authorization token to the mobile internet device. The authorization token may be a single-use authorization token that expires after use. In one embodiment, the authorization token may expire after a pre-determined time elapses.

In the case that the mobile internet device attempts to connect to the APC and is unsuccessful, the application installed on the mobile internet device retrieves a backup authorization token for use as the authorization token. The backup authorization token is retrieved from a memory of the mobile internet device in which it was stored after being previously transmitted to the mobile internet device by the APC. According to one embodiment, an approved transaction value associated with the backup authorization token may be stored in the memory of the mobile internet device and displayed on the mobile internet device when the backup authorization token is retrieved.

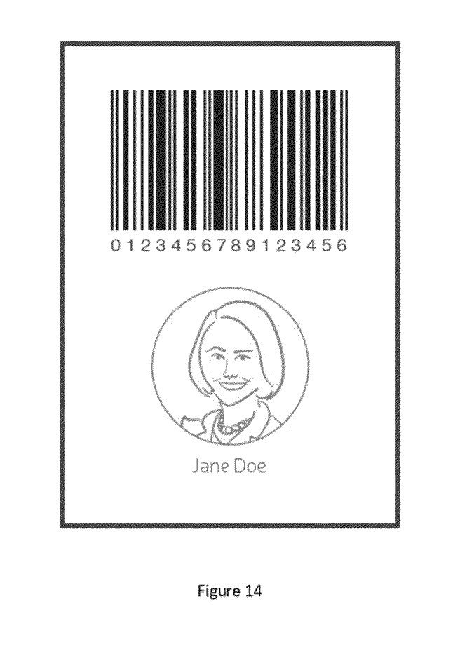

The application installed on the mobile internet device then displays the authorization token on the mobile internet device. The authorization token may be displayed on the mobile internet device as an alphanumeric code, a 1-d barcode, 2-d barcode, or combinations thereof. In another embodiment, the authorization token may be displayed on the mobile internet device as any appropriate symbol or graphic. An authorization token as displayed on a mobile internet device according to one embodiment is depicted in FIG. 14, along with an image of the consumer associated with the APC account. The authorization token is then entered in to the point-of-sale device. The entry of the authorization token may be carried out by manually entering a displayed alphanumeric code in to the point-of-sale device or by scanning a displayed barcode. In another embodiment, the authorization token may be transmitted to the point-of-sale device by any appropriate transmission process, for example the transmission may utilize bluetooth, infrared, near-field-communication, or any other transmission process. According to one embodiment, the mobile internet device may display the consumer's first name, last name, and picture, if a picture has been provided to the application installed on the mobile internet device, concurrently with the authorization token.

The point-of-sale device then transmits sale transaction information to the APC. Sale transaction information includes at least the authorization token and the sale transaction value. The sale transaction information may additionally include merchant identification information. According to one embodiment, the sale transaction value may additionally include other transaction value elements, such as a tip value, a tax value, a service charge value or others. The APC then verifies that the authorization token is valid and verifies the sale transaction value against the approved transaction value associated with the authorization token. The verification of the sale transaction value against tile approved transaction value includes determining that the sale transaction value does not exceed the approved transaction value.

According to one embodiment, the approved transaction value may be an amount of funds available in a bank account associated with the consumer's APC account at the time the authorization token was retrieved. In the case of a backup authorization token, the approved transaction, value may be an amount determined by the APC based on the consumer's financial information at the time the backup authorization token was transmitted to the mobile internet device. According to one embodiment, an approved transaction value associated with a backup authorization token may be the same as the approved transaction value associated with the consumer's APC account generally. The approved transaction value associated with a consumer's APC account may be a maximum monetary transaction value, a maximum monetary value of transactions in a pre-determined time period, a maximum number of transactions per unit of time, or other appropriate value. According to one embodiment, the approved transaction value may be a maximum monetary value of transactions in a multi-day period. According to another embodiment, an approved transaction value associated with a backup authorization token may be unique to the backup authorization token, such as an approved transaction value that is different from an approved transaction value associated with the consumer's APC account generally.

After verification of the sale transaction information, the APC transmits an approval message to the point-of-sale device. If verification of the sale transaction information is not successful, the APC may transmit a denial message to the point-of-sale device. After sending an approval message, the APC completes the payment transaction by transferring funds from the consumer to the merchant. In some embodiments, the funds deducted from the consumer's bank account by the APC may exceed the sale transaction, amount and/or the funds provided to the merchant by the APC may be less than the amount of the sale transaction value, as a result of usage fees assessed by the APC.

The payment may be completed by any appropriate funds transfer infrastructure. According to one embodiment, the payment may be conducted utilizing an automated clearing house (ACH) electronic network for financial transactions. In one embodiment, the payment may include utilizing the ACH network to debit funds from the consumer's account and credit funds to the merchant's account. The funds transfer infrastructure may include a delay between the initiation of the funds transfer and the crediting of funds to the merchant's account, such as a crediting of funds that occurs on the next banking day after the initiation of the funds transfer.

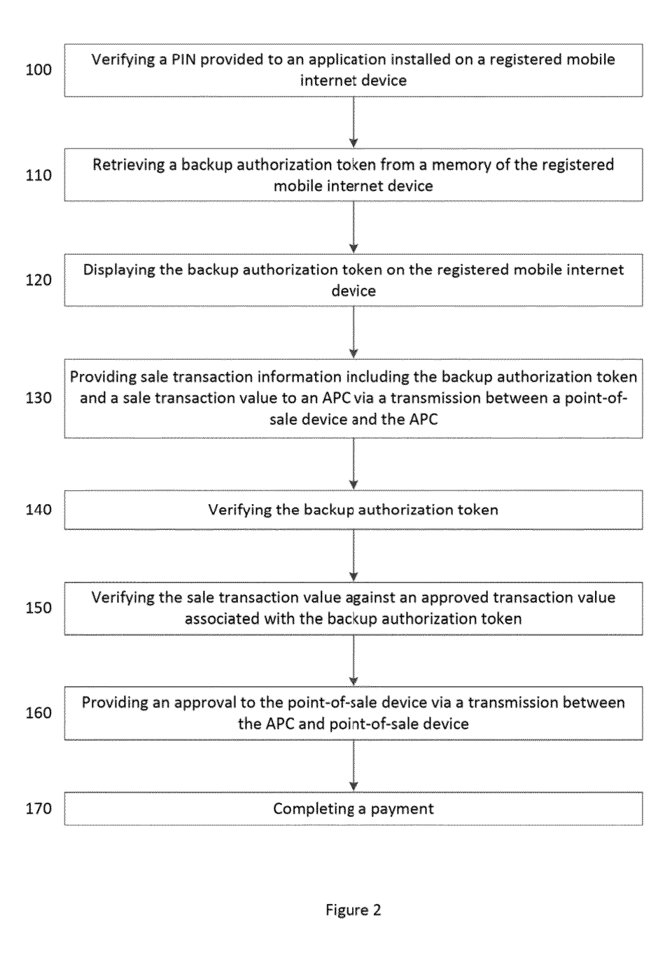

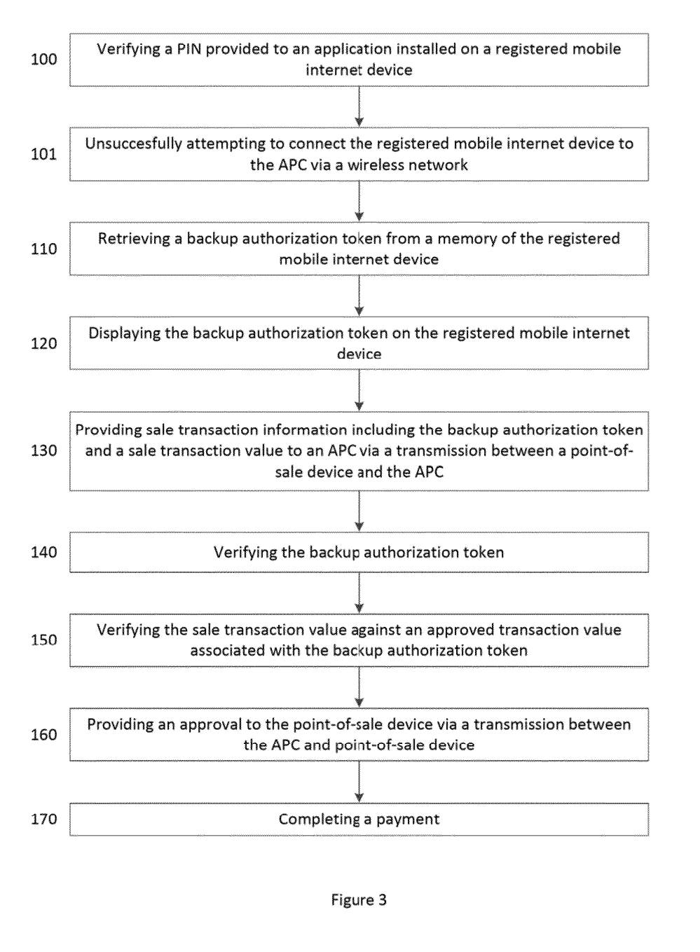

An exemplary process for conducting a cardless point-of-sale payment transaction utilizing a backup authorization token is depicted in FIG. 2. The process includes verifying a PIN provided to an application installed on the registered mobile internet device 100, retrieving a backup authorization token from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160 and completing a payment 170. The verification of the backup authorization token 140 and verification of the sale transaction value against an approved transaction value 150 may take place at the APC. According to one embodiment, verification of the authorization token and the subsequent steps in the payment process may be carried out by the APC. As depicted in FIG. 3, the process of conducting a cardless point-of-sale payment transaction utilizing a backup authorization token may include unsuccessfully attempting to connect the registered mobile internet device to the APC via a wireless network 101. The unsuccessful connection attempt 101 may occur after verifying the PIN 100 but before retrieving a backup authorization token 110. The attempt to connect may be unsuccessful if the mobile internet device is not connected to a wireless network or is unable to establish a connection to the APC.

For open-loop applications, the process of completing a cardless point-of-sale payment transaction may include a step of selecting a participating merchant from a participating merchant list displayed on the registered mobile internet device. The participating merchant list is provided to the mobile internet device by the APC, and may be transmitted at the time of the payment transaction or may be previously transmitted, stored in a memory of the mobile internet device and retrieved from the memory at the time of the payment transaction. According to one embodiment, the participating merchant list may be searched by the consumer to locate the desired merchant or may be narrowed by proximity of participating merchants to a detected location of the mobile internet device. The authorization token retrieved in the process may be specific to the participating merchant selected. For closed loop applications, there is no participating merchant selection step.

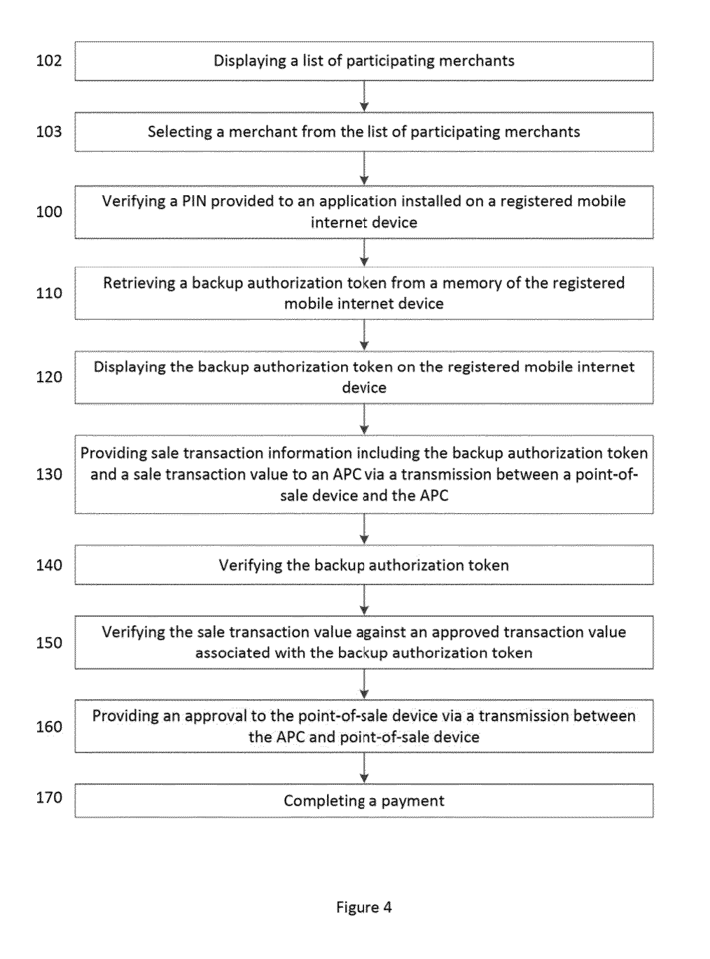

An exemplary process for completing a cardless point-of-sale payment transaction utilizing an open-loop application is depicted in FIG. 4. The process includes displaying a list of participating merchants 102, selecting a merchant from the list of participating merchants 103, verifying a PIN provided to an application installed on the registered mobile internet device 100, retrieving a backup authorization token from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 100 and completing a payment 170. The display of the participating merchant list 102 and selection of a participating merchant 103 may occur before the retrieval of a backup authorization token 110. According to one embodiment, the display of the participating merchant list 102 and selection of a participating merchant 103 may occur before verifying a PIN 100. According to another embodiment, the display of the participating merchant list 102 and selection of a participating merchant 103 may occur after verifying a PIN 100.

The process of completing a cardless point-of-sale payment transaction may include a step of selecting a payment tender option from a list of payment tender options presented be the registered mobile internet device. The presentation of a list of payment tender options may be included in the process when multiple payment accounts are linked to the consumer's APC account. The presentation of the payment tender options may include presentation of an approved transaction value associated with each payment tender option. According to one embodiment, no financial information relating to the payment tender options is stored by the mobile internet device, included in the authorization token or transmitted between the mobile internet device and the APC. In one embodiment, the authorization token retrieved in the process is specific to the payment tender option selected. According to another embodiment, a plurality of backup authorization tokens may be stored on the mobile internet device, such as a backup authorization token unique to each payment tender option associated with the consumer's APC account.

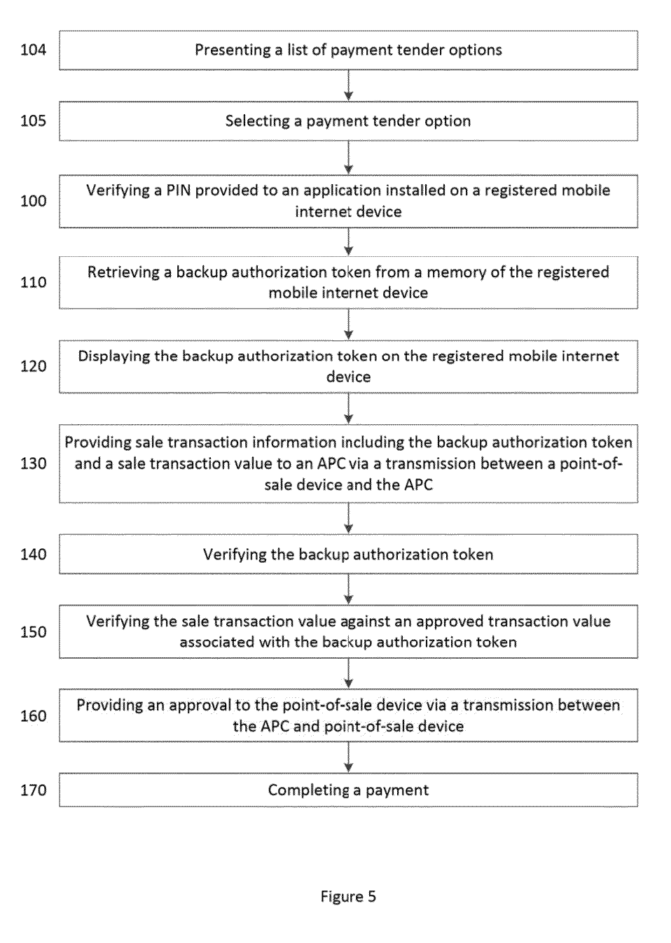

An exemplary process for completing a cardless point-of-sale payment transaction wherein multiple payment accounts are linked to a consumer's APC account is depicted in FIG. 5. The process includes presenting a list of payment tender options 104, selecting a payment tender option 105, verifying a PIN provided to an application installed on the registered mobile internet device 100, retrieving a backup authorization token from a memory of the registered mobile internet device 110, displaying the backup authorization token on the registered mobile internet device 120, providing sale transaction. Information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160 and completing a payment 170. According to one embodiment, the presentation of the payment tender options 104 and selection of a payment tender option 105 occurs before the retrieval of a backup authorization token 110. According to one embodiment, the presentation of the payment tender options 104 and selection of a payment tender option 105 may occur before verifying a PIN 100. According to another embodiment the presentation of the payment tender options 104 and selection of a payment tender option 105 may occur after verifying a PIN 100. The backup authorization token retrieved front the memory of the mobile internet device may be specific to the payment tender option selected.

The process for completing a cardless point-of-sale payment transaction may additionally include providing a replacement backup authorization token to the mobile internet device and storing the replacement backup authorization token in the memory of the mobile internet device. In the case that the backup authorization token is utilized to complete a payment transaction, a replacement backup authorization token may be provided to the mobile internet device when a connection between the mobile internet device and the APC is established. According to one embodiments the replacement backup authorization token is provided to the mobile internet device when a wireless network connection is established that the mobile internet device may utilize to connect to the APC. In another embodiment, after a pre-determined time period has elapsed after the creation of the backup authorization token a replacement backup authorization token may be provided to and stored in the memory of the mobile-internet device even if the backup authorization token has not been utilized to complete a payment transaction.

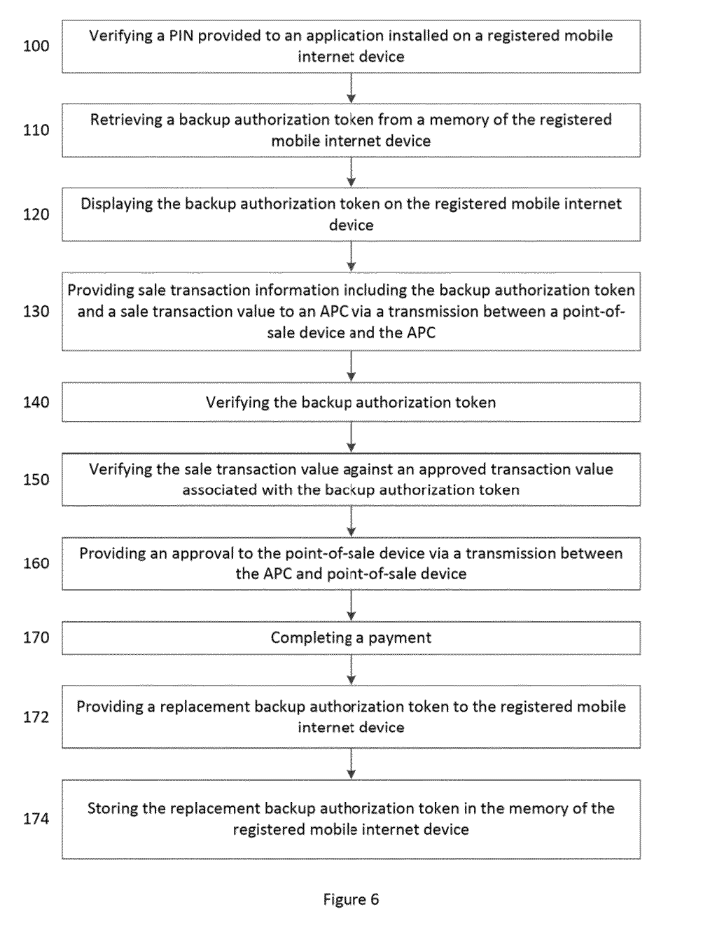

An exemplary process for completing a cardless point-of-sale payment transaction utilizing a backup authorization token including providing a replacement backup authorization token is depicted in FIG. 6. The process includes verifying a PIN provided to an application installed on the registered mobile internet device 100, retrieving a backup authorization token from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160, completing a payment 170, providing a replacement backup authorization token to the registered mobile internet device 172 and storing the replacement backup authorization token in the memory of the registered mobile internet device 174. According to one embodiment, providing the replacement backup authorization token 172 occurs when the mobile internet device establishes a connection to a wireless network that allows the mobile internet device to connect to the APC. According to another embodiment, providing the replacement backup authorization token 172 may occur after a predetermined time interval, upon request by the consumer, after the use of the backup authorization token to complete a payment transaction, or any other appropriate time. According to an alternative embodiment, a replacement backup authorization token may never be provided.

The process for completing a cardless point-of-sale payment transaction may additionally include the display of coupons on the mobile internet device. The coupons may be transmitted to the mobile internet device at the time of the payment transaction or transmitted to the mobile internet device at a time before the initiation of the payment transaction. In the case that the coupons are transmitted to the mobile internet device before the initiation of the payment transaction, the coupons may be stored in the memory of the mobile internet device, and retrieved from a memory of the mobile internet device during the process of completing a payment transaction. According to one embodiment the coupons may be tailored to participating merchants selected by the consumer or to merchants located within a pre-determined proximity to a location of the mobile internet device. The coupons may also be tailored on the basis of the consumer's demographic information, location, requests, inputs, historical shopping behavior and patterns, historical payment behavior and patterns, or other characteristics.

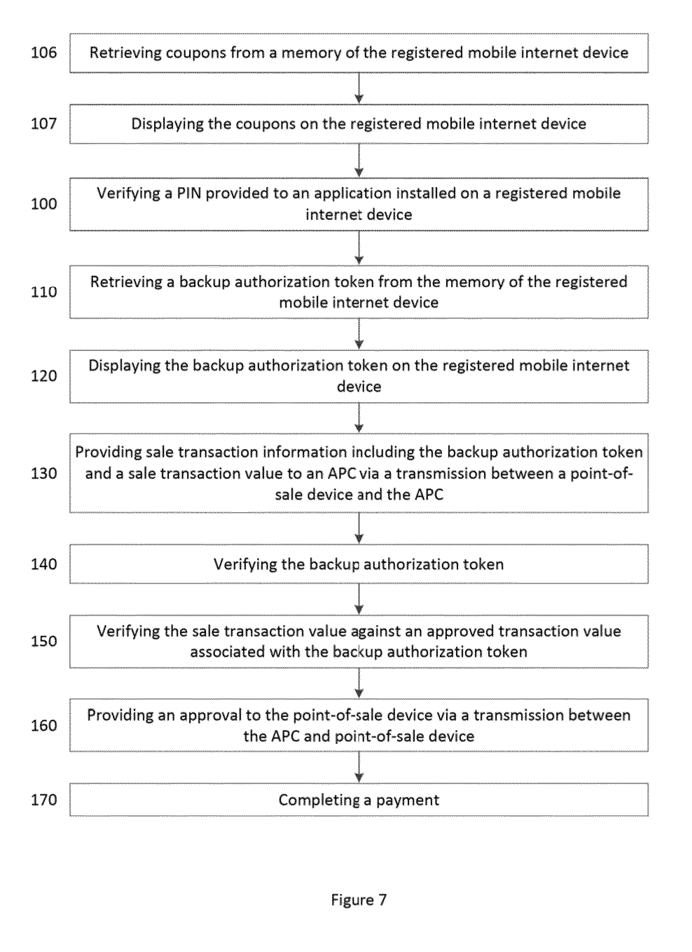

An exemplary process for completing a cardless point-of-sale payment transaction wherein coupons are displayed on the registered mobile internet device is depleted in FIG. 7. The process includes retrieving coupons from a memory of the registered mobile internet device 106, displaying the coupons on the registered mobile internet device 107, verifying a PIN provided to an application installed on the registered mobile internet device 100, retrieving a backup authorization token from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160 and completing a payment 170. According to one embodiment the retrieval 106 and display of the coupons 107 occurs before displaying the backup authorization token on the registered mobile device 120. In another embodiment the retrieval 106 and display of the coupons 107 occurs before verifying the PIN 100. In one embodiment, the retrieval 106 and display of the coupons 107 occurs after verifying the PIN 100. According to one embodiment the process may include attempting to connect to the APC to refresh and/or download coupons.

The process for completing a cardless point-of-sale payment transaction may additionally include the display of marketing information on the mobile internet device. The marketing information may include advertisements for merchants or specific products and services. According to one embodiment, the marketing information may include videos. The marketing information may be transmitted to the mobile internet device at the time of the payment transaction or transmitted to the mobile internet device at a time before the initiation of the payment transaction. In the case that the marketing information is transmitted to the mobile internet device before the initiation of the payment transaction the marketing information may be stored in the memory of the mobile internet device, and retrieved from a memory of the mobile internet device during the process of completing a payment transaction. According to one embodiment, the marketing information may be tailored to participating merchants selected by the consumer or to merchants located within a pre-determined proximity to a location of the mobile internet device. The marketing information may also be tailored, on the basis of the consumer's demographic information, location, requests, inputs, historical shopping behavior and patterns, historical payment behavior and patterns, or other characteristics.

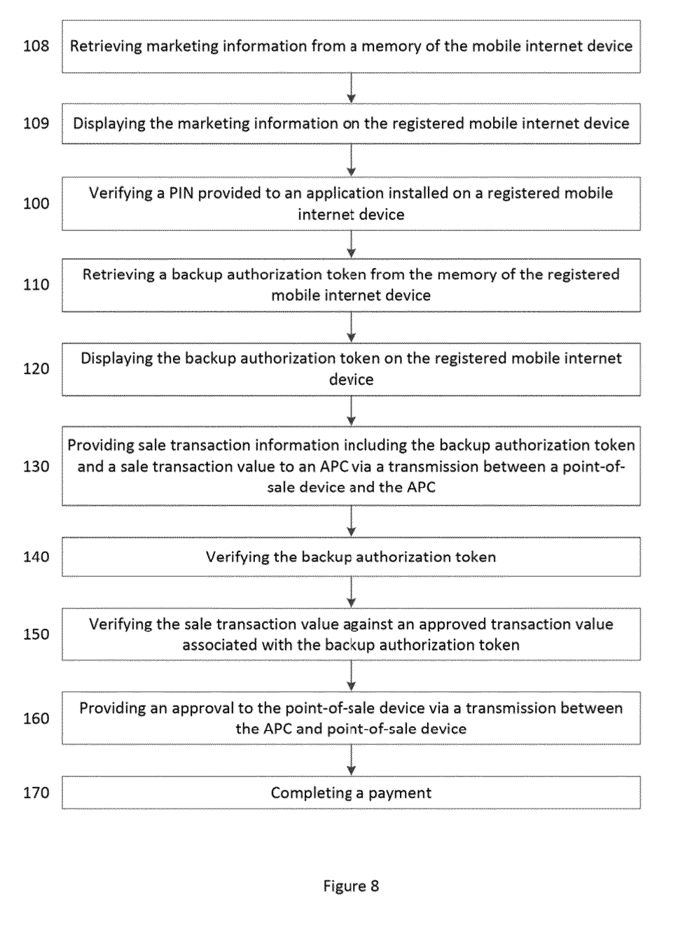

An exemplary process for completing a cardless point-of-sale payment transaction wherein marketing information is displayed on the registered mobile internet device is depicted in FIG. 8. The process includes retrieving marketing information from a memory of the registered mobile internet device 108, displaying the marketing information on the registered mobile internet device 109, verifying a PIN provided to an application installed on the registered mobile internet device 100, retrieving a backup authorization token from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160 and completing a payment 170. According to one embodiment, the retrieval 108 and display of the marketing information 109 occurs before displaying the backup authorization token on the registered mobile device 120. In another embodiment, the retrieval 108 and display of the marketing information 109 occurs before verifying the PIN 100. In one embodiment, the retrieval 108 and display of the marketing information 109 occurs after verifying the PIN 100. According to one embodiment, the process may include attempting to connect to the APC to refresh and/or download marketing information.

The process for completing a cardless point-of-sale payment transaction may additionally include the display of an approved transaction amount associated with an authorization token on the mobile internet device. The display of the approved transaction amount may allow the consumer to avoid the rejection of a payment transaction for exceeding the approved transaction amount. According to one embodiment, the approved transaction amount may be transmitted to the mobile internet device at the same time as the authorization token. In the case of a backup authorization token, the approved transaction amount may be transmitted to the mobile internet device at the same time as the backup authorization token, stored in the memory of the mobile internet device and retrieved at the time that backup authorization token is retrieved from the memory of the mobile internet device. The approved transaction amount may be displayed concurrently with the authorization token on the mobile internet device, before displaying the authorization token on the mobile internet device, or after displaying the authorization token on the mobile internet device.

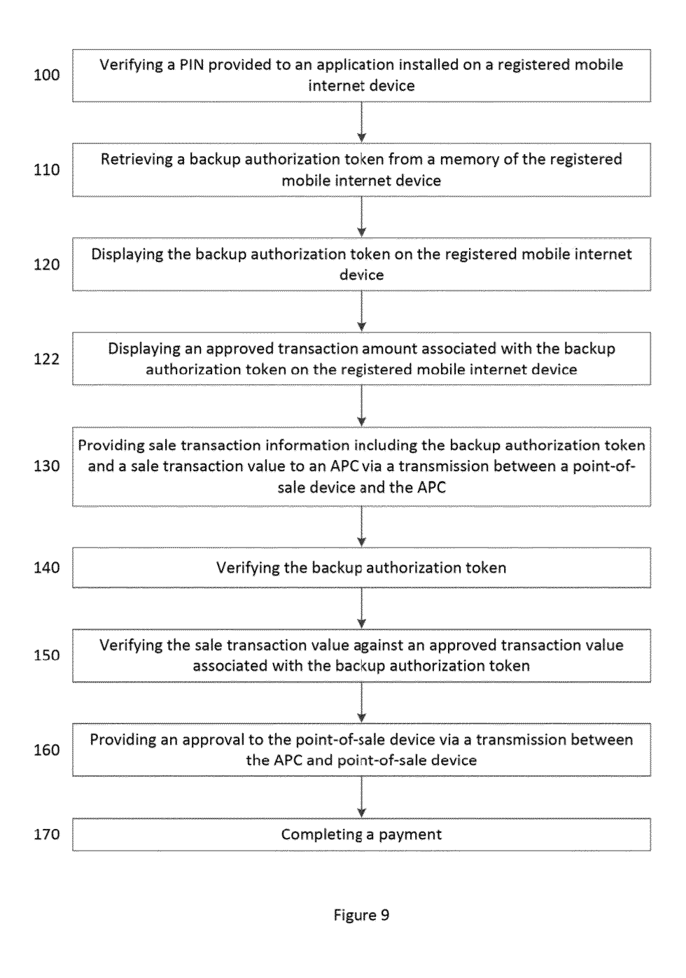

An exemplary process for completing a cardless point-of-sale payment transaction wherein an approved transaction amount associated with a backup authorization token is displayed on the registered mobile internet device is depicted in FIG. 9. The process includes verifying a PIN provided to an application installed on the registered mobile internet device 100, retrieving a backup authorization token from a memory of the registered mobile internet device 110, displaying the backup authorization token on the registered mobile internet device 120, displaying an approved transaction amount associated with the backup authorization token on the registered mobile internet device 122, providing sale transaction information to an APC via a transmission between a point-of-sale device and the APC 130, verifying the backup authorization token 140, verifying the sale transaction value against an approved transaction value associated with the backup authorization token 150, providing an approval to the point-of-sale device via a transmission between the APC and the point-of-sale device 160 and completing a payment 170. According to one embodiment, the display of the approved transaction amount on the mobile internet device 122 may be concurrent with the display of the backup authorization token on the mobile internet device 120. In another embodiment, the display of the approved transaction amount on the mobile internet device 122 may occur before or after the display of the backup authorization token on the mobile internet device 120.

The process for completing a cardless point-of-sale payment transaction may be utilized to carry out a payment transaction utilizing a gift card account. A gift card account may be associated with the consumer's APC account, and subsequently utilized as a payment tender option for completing a payment transaction utilizing the cardless point-of-sale system. According to one embodiment, an approved transaction-amount-associated with the authorization token is a balance amount associated with the gift card account when the authorization token is transmitted to the mobile internet device. The approved transaction amount may be transmitted to the mobile internet device at the same time as the authorization token. In the case of a backup authorization token, the approved transaction amount may be transmitted to the mobile internet device at the same time as the backup authorization token, stored in the memory of the mobile internet device and retrieved at the time that the backup authorization token is retrieved from the memory of the mobile internet device. In one embodiment the approved transaction amount may be displayed on the mobile internet device. The approved transaction amount may be displayed concurrently with the authorization token on the mobile internet device, before displaying the authorization token on the mobile internet device, or after displaying the authorization token on the mobile internet device. When utilizing a gift card account to complete the payment transaction, the approval of the transaction may include an additional verification that the balance amount associated with the gift card account has not changed since the transmission of the authorization token to the mobile internet device. If the balance of the gift card account has not changed, the verification of the payment transaction proceeds normally. In the case that the gift card account balance has changed, the APC may verify the balance of the gift card account against the sale transaction value to determine if the payment transaction should be approved. This additional step allows the APC to ensure that the gift card account has a balance that is equivalent to or exceeding the approved transaction value at the time of the payment transaction.

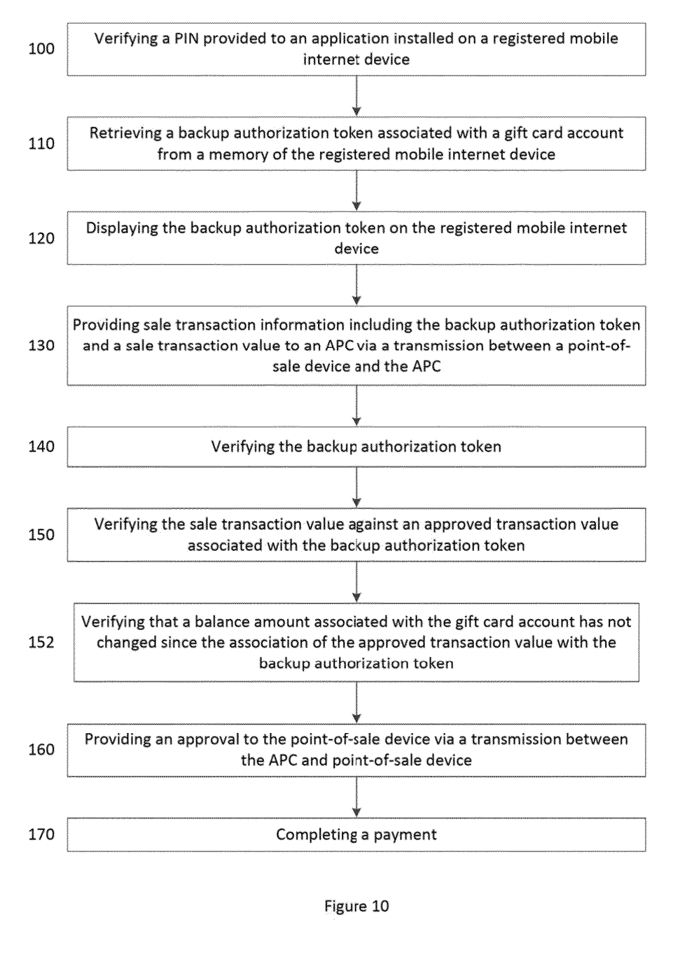

An exemplary process for completing a cardless point-of-sale payment transaction with a backup authorization token associated with a gift card account is depicted in FIG. 10. The process includes verifying a PIN provided to an application installed on the registered mobile internet device 100, retrieving a backup authorization token associated with a gift card account from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction valise associated with the backup authorization token 150, verifying that a balance amount associated with the gift card account has not changed since the association of the approved transaction value with the backup authorization token 152, providing an approval to the point-of-sale device via a transmission between the APC and the point-of-sale device 160 and completing a payment 170.

The backup authorization token utilized in the cardless point-of-sale payment process may be a single-use or multiple-use authorization token. A single-use authorization token expires after being utilized to complete a single payment transaction, and cannot be utilized for additional payment transactions. A multiple-use authorization token may be utilized to complete more than one payment transaction. Multiple-use authorization tokens allow a consumer to complete multiple payment transactions while the mobile internet device is unable to connect to a wireless network capable of establishing a connection to the APC. Additional verification procedures may be employed when a multiple-use backup authorization token is employed. According to one embodiment, the approval of a payment transaction utilizing a multiple-use backup authorization token may include determining a value of transaction(s) that have previously utilized the multiple-use backup authorization token and verifying that the sum of the value of the previous transaction(s) and the sale transaction value is less than or equal to the approved transaction value associated with the backup authorization token. In the case that the sum of the value of the previous transaction(s) and the sale transaction value exceeds the approved transaction value associated with the backup authorization token, the APC may transmit a payment transaction denial to the point-of-sale device. A multiple-use backup authorization token may expire when a connection between the registered mobile internet device and the APC is established. According to another embodiment, a multiple-use backup authorization token may expire after a pre-determined number of payment transactions and/or after a pre-determined amount of time from the first use of the multiple-use backup authorization token-to complete a payment transaction.

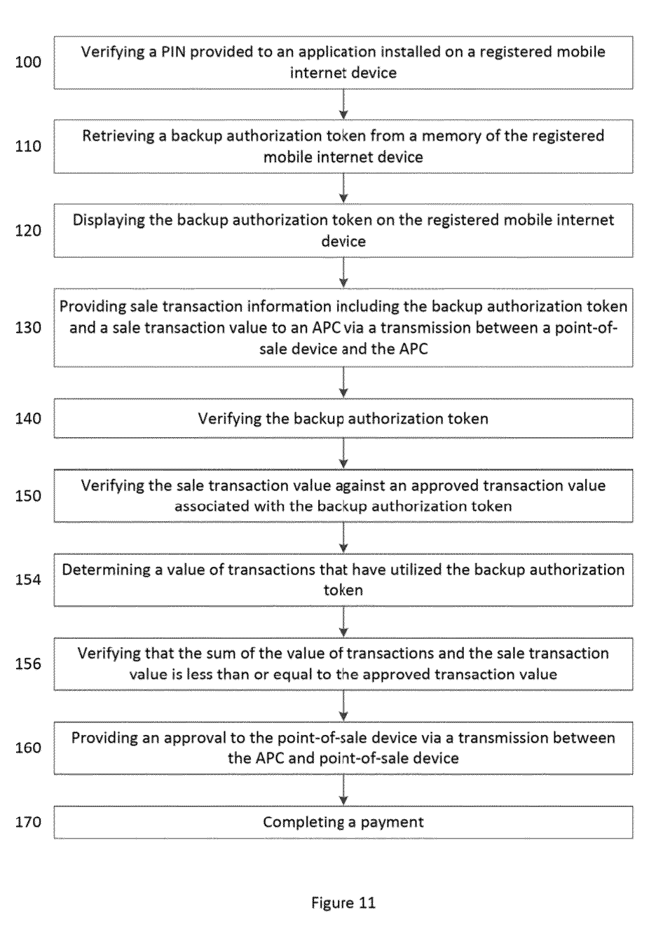

An exemplary process for completing a cardless point-of-sale payment transaction with a multiple-use backup authorization token is depicted in FIG. 11. The process includes verifying a PIN provided to an application installed on the registered mobile internet device 100, retrieving a multiple-use backup authorization token associated with a gift card account associated with an APC account from a memory of the registered mobile internet device 110, displaying the backup authorization token on the registered mobile internet device 120, providing sale transaction information to an APC via a transmission between a point-of-sale device and the APC 130, verifying the backup authorization token 140, verifying the sale transaction value against an approved transaction value associated with the backup authorization token 150, determining a value of transaction(s) that have utilized the backup authorization token 154, verifying that the sum of the value of the previous transaction(s) and the sale transaction value is less than or equal to the approved transaction value associated with the backup authorization token 156, providing an approval to the point-of-sale device via a transmission between the APC and the point-of-sale device 160 and completing a payment 170. According to one embodiment, the determination of the value of the previous transaction(s) 154 and the verification of the sum of the value of the previous transaction(s) and the sale transaction value against the approved transaction value 156 may occur concurrently with or after the verification of the sale transaction value against the approved transaction value 150.

According to one embodiment, no consumer financial or personal information is provided to the point-of-sale device or transmitted to the APC throughout the payment transaction process. Financial information may include bank account numbers, credit card account numbers, debit card account numbers, gift card account numbers, or account balances. Personal information may include an account owner's name, mailing address, telephone number, email address, PIN, picture, APC account number, social security number or biometric data. The lack of transmission of personal and financial information reduces opportunities for interception of such information by third parties, increasing the security of the payment transaction.

Any of the additional features of the cardless point-of-sale system described above in relation to a process employing a backup authorization token may also be applied to cardless point-of-sale processes that do not employ a backup authorization token.

A method of operating a cardless point-of-sale system that includes a computer network and a wireless network is provided according to one embodiment. The cardless point-of-sale system may be utilized to conduct payment transactions according to any of the processes described herein. The method of operation provides an incentive to merchants when consumers that have created an APC account to conduct payment transaction(s) with the merchant later utilize the APC account to conduct payment transactions with other merchants. The merchant responsible for the creation of the consumer's APC account may be referred to as an account origination merchant. An account origination merchant may be established when a consumer utilizes a merchant's closed loop application or website to create an APC account or when a consumer is directed by a merchant to create an APC account, for example by the merchant providing a hyperlink to a website associated with the APC. The identity of the account origination merchant is associated with the consumer's APC account.

The incentive may be provided to the account origination merchant when an associated APC account is utilized to conduct a payment transaction with a second merchant. According to one embodiment, an incentive is provided to the merchant for only the first unique merchant that the associated APC account is utilized to complete a transaction with after the account origination merchant, with no additional incentive payments provided to the account origination merchant. A unique merchant is a merchant that has not been a party to previously completed payment transactions utilizing the associated APC account. In another embodiment, the account origination merchant may receive an incentive for additional completed payment transaction with a unique merchant. In some cases, art incentive may be provided for a limited number of unique merchant payment transactions or for all unique merchant payment transactions.

The incentive to the account origination merchant may be provided in the form of monetary benefits. According to one embodiment, direct payments are provided to the account origination merchant. In another embodiment, the account origination merchant may receive a credit reducing the merchant's transaction fees associated with the use of the cardless point-of-sale system. The value of the incentive may be constant as the APC account is utilized across a plurality of unique merchants. Alternatively, the value of the incentive may change according to a predetermined schedule or formula as the associated APC account is utilized with additional unique merchants.

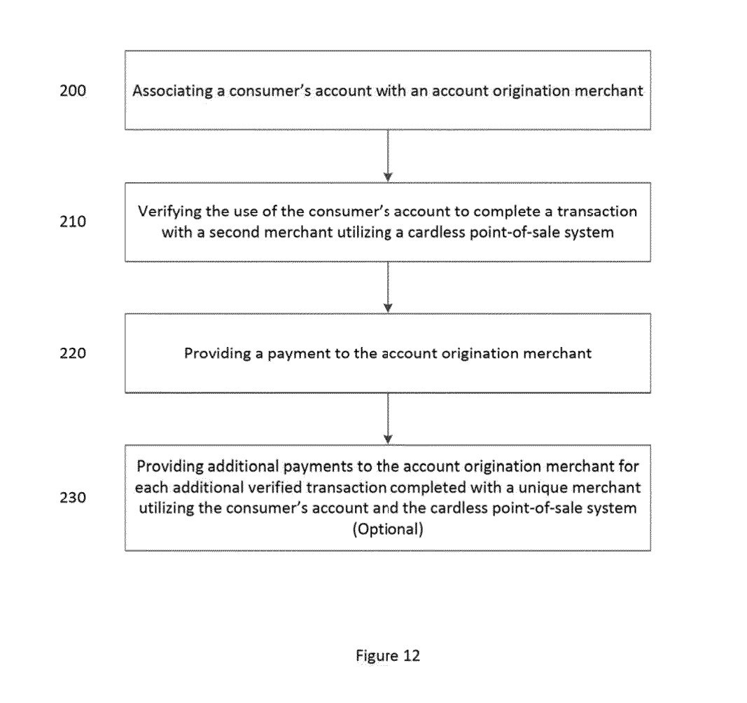

An exemplary method of operating a cardless point-of-sale payment system including payments to an account origination merchant is depicted in FIG. 12. The method includes associating a consumer's account with an account origination merchant 200, verifying the use of the consumer's account to complete a transaction with a second merchant utilizing the cardless point-of-sale system 210, providing a payment to the account origination merchant 220 and providing additional payments to the account origination merchant for each additional verified transaction completed with a unique merchant utilizing the consumer's account and the cardless point-of-sale payment system 230. The step of providing additional payments to the account origination merchant 230 is optional and depends on the desired incentive structure utilized to operate the cardless point-of-sale system. The transaction with the second merchant utilizing the point-of-sale system 210 may be completed utilizing any of the processes described herein. According to one embodiment, at least one of the account origination merchant and the second merchant is an online retailer.

According to one embodiment, the cardless point-of-sale payment system may be utilized to complete peer-to-peer payment transfers. In this embodiment, a payer APC account may be considered the “consumer” and the payee APC account may be considered the “merchant,” with the registered mobile internet device associated with the payee APC account is the “point-of-sale device.”

According to one embodiment, multiple users may be linked to a single APC account. In another embodiment, the cardless point-of-sale payment system may be utilized to process merchandise and/or payment returns.

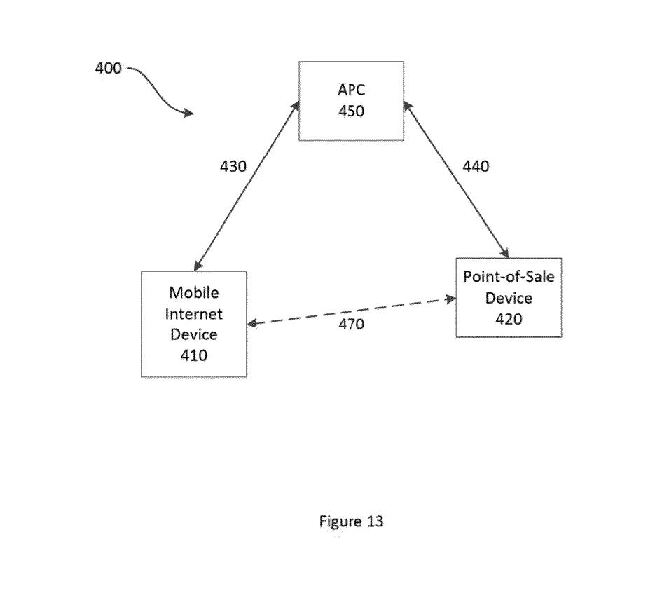

The cardless point-of-sale payment process described herein may be operated utilizing a computer network 400 as depicted in FIG. 13. The computer network 400 includes a wireless network 430 that allows a mobile internet device 410 to establish a connection to an APC 450, The computer network 400 also includes a network connection 440 that allows a point-of-sale device 420 to establish a connection to the APC 450. In some embodiments, the computer network 400 may additionally include a network connection that allows the APC 450 to connect to a payment processor. The transmission of information 470, such as the authorization token, between the mobile internet device 410 and the point-of-sale device 420 may be conducted by means other than the wireless network 430 and network connection 440, as previously described.

It should be appreciated that all combinations of the foregoing concepts (provided such concepts are not mutually inconsistent) are contemplated as being part of the inventive subject matter disclosed herein. All combinations of claimed subject matter appearing at the end of this disclosure are contemplated as being part of the inventive subject matter disclosed herein.

The indefinite articles “a” and “an,” as used herein in the specification and in the claims, unless clearly indicated to the contrary, should be understood to mean “at least one.”

It should be understood that various changes in form and detail may be made by one of ordinary skill in the art without departing from the spirit and scope of the appended claims.

1. A cardless point-of-sale payment method, comprising:
verifying a personal identification number (PIN) provided to an application installed on a registered mobile internet device at the application installed on the registered mobile internet device;
attempting to connect the application installed on the registered mobile internet device to a purchase authorization processing company (APC) via a wireless network;
determining that the attempt to connect the application installed on the registered mobile internet device to the APC is unsuccessful; then
retrieving a backup authorization token from a memory of the registered mobile internet device through the application installed on the registered mobile internet device;
displaying the backup authorization token on the registered mobile internet device for entry to a point-of-sale device through the application installed on the registered mobile internet device;
receiving sale transaction information at the APC via a transmission between the point-of-sale device and the APC, wherein the sale transaction information includes the backup authorization token and a sale transaction value;
verifying the backup authorization token at the APC;
verifying the sale transaction value against an approved transaction value associated with the backup authorization token at the APC;
providing an approval to the point-of-sale device via a transmission from the APC to the point-of-sale device; and
completing the payment through the APC.

2. (canceled)

3. The method of claim 1, wherein no account owner personal or financial information is provided to the point-of-sale device or transmitted to the APC.

4. The method of claim 1, wherein the method further comprises:
establishing an account at the APC;
installing the application on a mobile internet device;
registering the mobile internet device with the APC, such that the registered mobile internet device is established;
providing the backup authorization token from the APC to the application installed on the registered mobile internet device; and
storing the backup authorization token provided to the application installed on the registered mobile internet device in the memory of the registered mobile internet device.

5. The method of claim 1, wherein the method further comprises:
searching a list of participating merchants;
selecting a merchant from the list of participating merchants.

6. The method of claim 1, wherein the method further comprises:
presenting a list of payment tender options; and
selecting a payment tender option.

7. The method of claim 6, wherein the list of payment tender options includes the approved transaction amount associated with the backup authorization token for at least one payment tender option.

8. The method of claim 1, wherein the method further comprises:
providing a replacement backup authorization token from the APC to the application installed on the registered mobile internet device when a connection between the registered mobile internet device and the APC is established; and
storing the replacement backup authorization token in the memory of the registered mobile internet device.

9. The method of claim 1, wherein the backup authorization token is a single-use backup authorization token.

10. The method of claim 1, wherein the backup authorization token may be utilized for multiple sale transactions.

11. The method of claim 1, further comprising:
retrieving coupons from the memory of the registered mobile internet device; and
displaying the coupons on the registered mobile internet device.

12. The method of claim 1, further comprising:
retrieving marketing information from the memory of the registered mobile internet device; and
displaying the marketing information on the registered mobile internet device.

13. The method of claim 1, further comprising:
displaying the approved transaction value associated with the backup authorization token on the registered mobile internet device, wherein the approved transaction value associated with the backup authorization token is stored in the memory of the registered mobile internet device.

14. The method of claim 1, wherein the backup authorization token is associated with a gift card account at the APC, and verifying the sale transaction value further comprises:
verifying that a balance associated with the gift card account at the APC has not changed since the association of the approved transaction value with the backup authorization token.

15. The method of claim 1, wherein verifying the sale transaction value further comprises:
determining a value of transactions that have utilized the backup authorization token at the APC; and
verifying that a sum of the value of transactions and the sale transaction value is less than or equal to the approved transaction value at the APC.

16. The method of claim 1, wherein the backup authorization token provided to the APC expires when a connection between the registered mobile internet device and the APC is established.

17. A method of operating a cardless point-of-sale payment system that includes a computer network and a wireless network, comprising:
associating a consumer's account with an account origination merchant;
verifying the use of the consumer's account to complete a transaction with a second merchant utilizing the cardless point-of-sale payment system; and
providing a payment to the account origination merchant.

18. The method of claim 17, further comprising providing a payment to the account origination merchant for each additional verified transaction completed with unique merchants utilizing the consumer's account and the cardless point-of-sale system.

19. The method of claim 17, wherein the account origination merchant receives no additional payments as the result of verified transactions completed with unique merchants utilizing the consumer's account and the cardless point-of-sale system.

20. The method of claim 17, wherein at least one of the account origination merchant and the second merchant is an online retailer.

21. A non-transitory computer readable medium, wherein the non-transitory computer readable medium comprises a software program configured to:
verify a personal identification number (PIN) provided to an application installed on a registered mobile internet device;
retrieve a backup authorization token from a memory of the registered mobile internet device; and
display the backup authorization token on the registered mobile internet device for entry to a point-of-sale device.

22. A registered mobile internet device, comprising a backup authorization token.

23. A cardless point-of-sale payment method, comprising:
verifying a personal identification number (PIN) provided to an application installed on a registered mobile internet device at the application installed on the registered mobile internet device;
attempting to connect the application installed on the registered mobile internet device to a purchase authorization processing company (APC) via a wireless network;
determining that the attempt to connect the application installed on the registered mobile internet device to the APC is unsuccessful; then
retrieving a backup authorization token from a memory of the registered mobile internet device through the application installed on the registered mobile internet device;
displaying the backup authorization token on the registered mobile internet device configured for entry to a point-of-sale device through the application installed on the registered mobile internet device.
